(19) United States
(12) Patent Application Publication
(10) Pub. No.: US 2010/0318321 A1
(43) Pub. Date: Dec. 16, 2010

(54) PEDESTAL NAVIGATION SYSTEM

(75) Inventor: Richard Arthur LINDSAY, Kenton (GB)

Correspondence Address: FELLERS SNIDER BLANKENSHIP;BAILEY & TIPPENS, THE KENNEDY BUILDING, 321 SOUTH BOSTON SUITE 800, TULSA, OK, 74103-3318, US

(73) Assignee: THE VITEC GROUP PLC, Kingston Upon Thames (GB)

(21) Appl. No.: 12/816,172

(22) Filed: Jun. 15, 2010

(30) Foreign Application Priority Data
Jun. 16, 2009 (GB) 0910360.7

(51) Int. Cl. G06F 15/00; G01B 21/22

(52) U.S. Cl. 702/151

(57) ABSTRACT

This invention provides a pedestal for a TV, video or cine camera comprising a base supported on at least three steerable wheel units, a steering system for the wheel units for maintaining the wheel units in parallel alignment with one another, a monitoring system for the wheel units and the steering system, and means for determining the distance moved by each wheel unit and the angle steered in relation to a fixed axis defined on the base. The monitoring system having processor means for calculating from the distances moved by every one of at least three wheels and the angle steered by every one of the at least three wheels in relation to the fixed axis, the trajectory distance traveled and any change of orientation of the pedestal to enable the position and orientation of the pedestal to be determined in relation to a previously known position and orientation.

### CROSS-REFERENCE TO RELATED APPLICATIONS

The application claims priority to United Kingdom Patent Application No. 0910360.7 filed 16 Jun. 2009 which is incorporated herein by specific reference.

### BACKGROUND TO THE INVENTION

The invention relates to a pedestal for TV, video or cine cameras and is particularly concerned with the navigation of such pedestals.

### SUMMARY OF THE INVENTION

This invention provides a pedestal for a TV, video or cine camera comprising a base supported on at least three steerable wheel units, a steering system for the wheel units for maintaining the wheel units in parallel alignment with one another, a monitoring system for the wheel units and the steering system and means for determining the distance moved by each wheel unit and the angle steered in relation to a fixed axis defined on the base, the monitoring system having processor means for calculating from the distances moved by every one of said at least three wheels and the angle steered by every one of said at least three wheels in relation to said fixed axis, the trajectory distance traveled and any change of orientation of the pedestal to enable the position and orientation of the pedestal to be determined in relation to a previously known position and orientation.

For example the monitoring means may be programmed to determine from the as measured distances traveled by at least three wheels and the angle steered with respect to the reference angle a closest approximation for the travel and orientation change of the pedestal.

More specifically the monitoring system may relate to the as measured distances of at least three wheels using a selected mathematical function to determine the corresponding distance traveled by the pedestal and change of orientation of the pedestal.

Further, the monitoring system may be programmed to calculate the closest approximation of the values of distance traveled by the pedestal and orientation change of the pedestal using a “least squares rule” mathematical function.

In any of the above arrangements the base of the pedestal may be generally triangular and may be supported on steerable wheel units located at the apices of the triangle.

Also in any of the above arrangements the steering system of the pedestal may have alternative modes, in one of which all three wheels are steered together in parallel alignment and in the other of which two wheels are locked against steering movement and the third wheel is free to steer the pedestal. When the pedestal is in steer mode the arrangement according to the invention as set out above for monitoring change in position and orientation is not applicable.

In one embodiment of the invention the at least three wheel units are motorized wheel units.

The foregoing has outlined in broad terms the more important features of the invention disclosed herein so that the detailed description that follows may be more clearly understood, and so that the contribution of the instant inventors to the art may be better appreciated. The instant invention is not limited in its application to the details of the construction and to the arrangements of the components set forth in the following description or illustrated in the drawings. Rather the invention is capable of other embodiments and of being practiced and carried out in various other ways not specifically enumerated herein. Additionally, the disclosure that follows is intended to apply to all alternatives, modifications and equivalents as may be included within the spirit and the scope of the invention as defined by the appended claims. Further, it should be understood that the phraseology and terminology employed herein are for the purpose of description and should not be regarded as limiting, unless the specification specifically so limits the invention.

### BRIEF DESCRIPTION OF THE DRAWINGS

The following is a description of a specific embodiment of the invention, reference being made to the accompanying drawings, in which:

FIG. 1 is a perspective view of a pedestal for mounting a TV/video camera including a telescopic column for adjusting the height at which the camera is supported by the pedestal;

FIG. 2 is a side view of the pedestal shown in FIG. 1 with the column lowered to its minimum height;

FIG. 3 is a plan view of the pedestal shown in FIGS. 1 and 2;

FIG. 4 is a block diagram showing the onboard microprocessor and encoder which supply information to the microprocessor;

FIGS. 5 and 6 are diagrammatic views of the pedestal showing how the position and orientation of the pedestal is calculated with respect to a previous position and orientation.

### DETAILED DESCRIPTION OF A PREFERRED EMBODIMENT

The present invention relates to a pedestal for supporting a TV/video/cine camera for movement over a studio floor or other working area with a monitoring system to enable the position and orientation of the pedestal to be determined in relation to a previously known position and orientation.

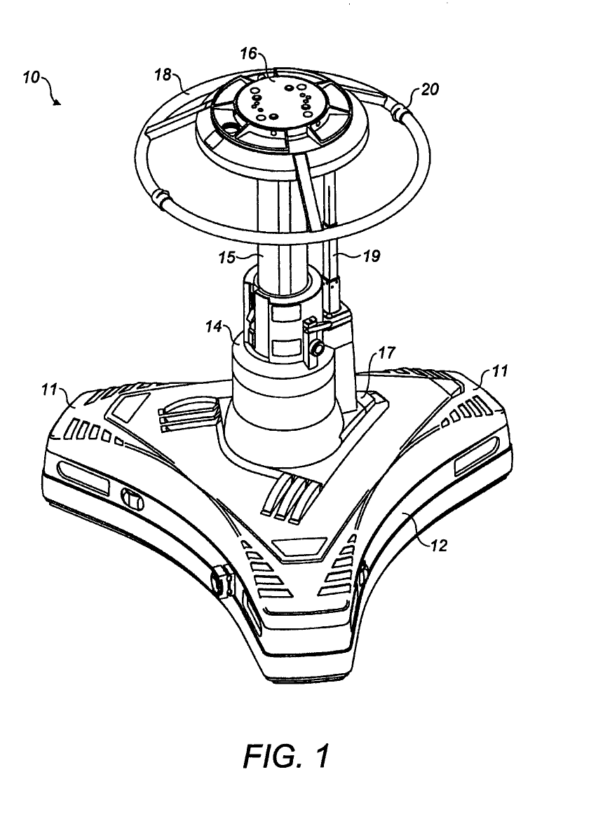

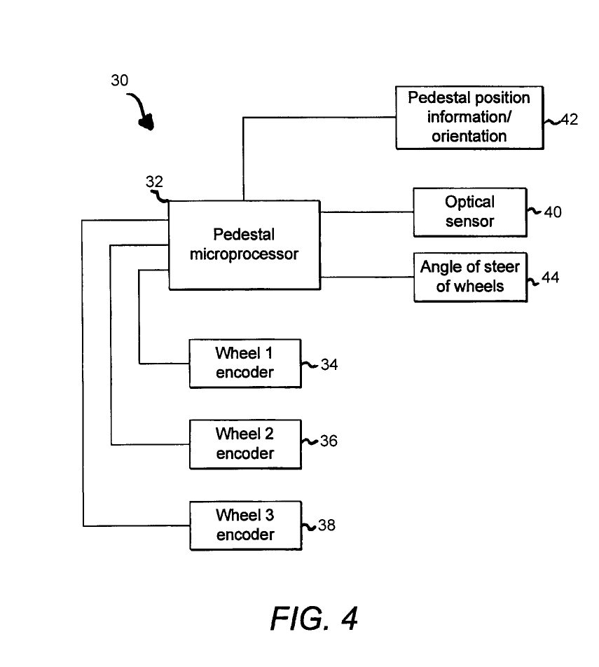

FIGS. 1 to 3 show a typical pedestal to which the system is applicable. The pedestal comprises a base 10 of generally equilateral triangular form having apices 11 and concave sides 12.

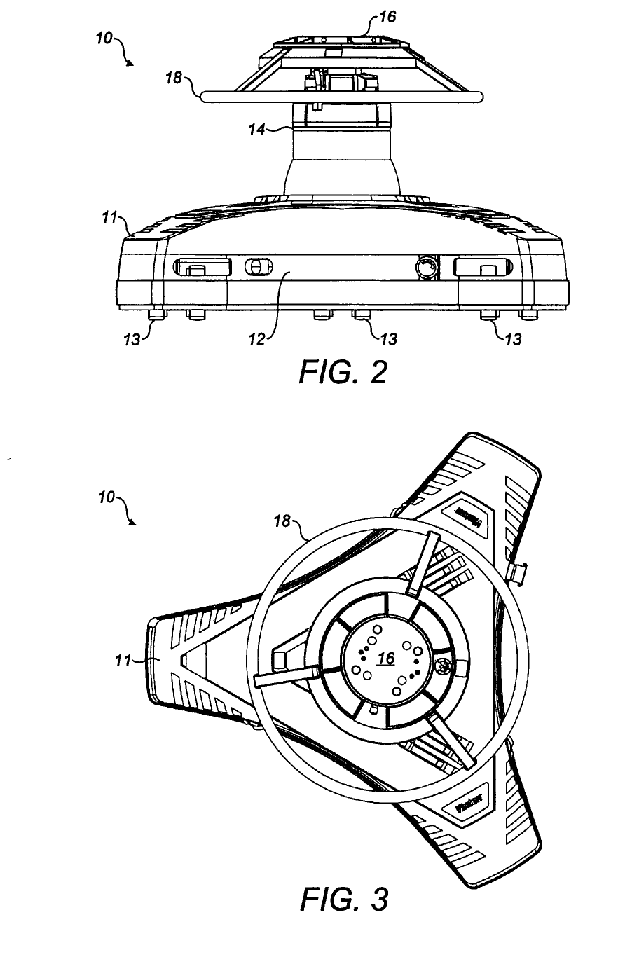

The base is preferably mounted on double wheel units 13 which can be seen projecting below the base in FIG. 2 of the drawings. The wheel units are located at the respective vertices 11 of the base and are mounted for steering about vertical axis for controlling the direction of movement of the pedestal.

At the centre of the base 10 there is generally cylindrical mounting 14 for a vertically extendible column 15. The column has a mounting plate 16 at its upper end to receive a pan and tilt head for supporting a TV/video/cine camera on the column.

The wheel units are interconnected by the mechanism to enable the pedestal to be moved in crab or steer mode. It will be appreciated that the monitoring system of the present invention only applies to use of the pedestal when in crab mode. A pedal 17 located on the base 10 adjacent the bottom end of the mounting 14 is provided for switching the steering mechanism between crab and steer modes. In steer mode two of the wheel units are locked in position to run parallel with one another and the third wheel is available for steering the pedestal. Steering is effected through a steering ring 18 encircling the mounting plate 16 and driving the steering mechanism through a telescopically adjustable steering rod 19 extending parallel with the column.

In crab mode all three wheel units are interlinked to steer simultaneously and the pedestal travels in the direction of the steering indicator 20 on the steering ring. This allows the operator to follow easily the action on-shot, tracking in and out, or crabbing from side to side with minimal effort.

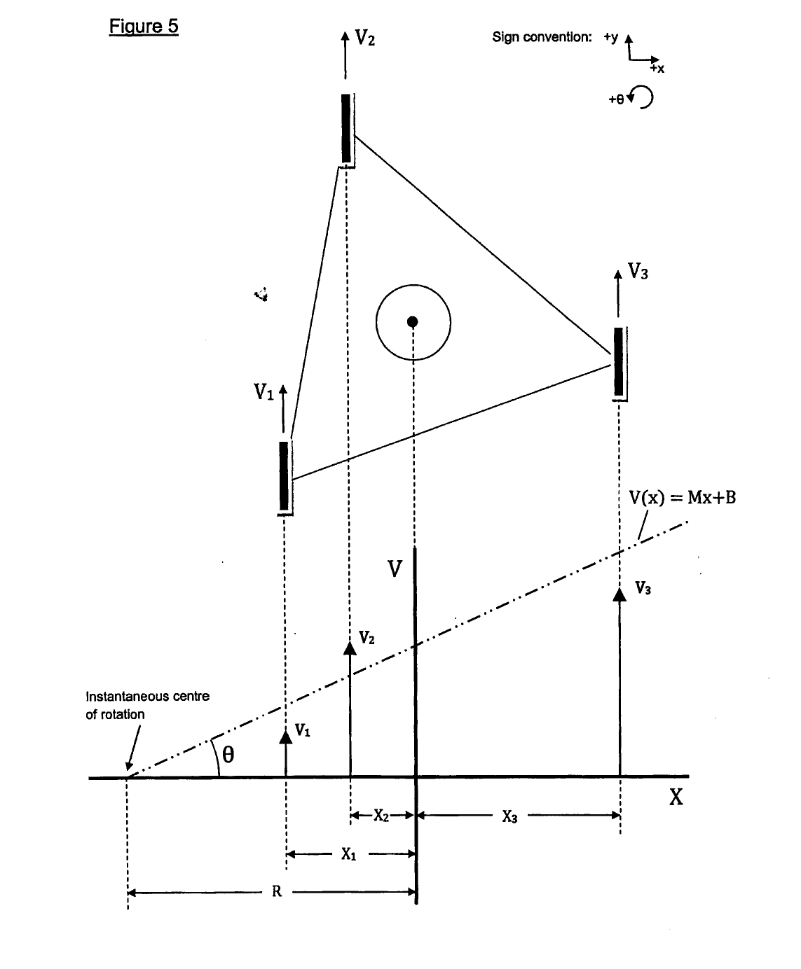

Referring to FIG. 4 of the accompanying drawings, the pedestal incorporates a monitoring system 30 for enabling the position and orientation of the pedestal to be determined in relation to a previously known position and orientation. The monitoring system includes a microprocessor 32 programmed to calculate the position and orientation of the pedestal from information supplied to the processor. Such information may include pedestal position/orientation information 42 and the angle steered by each of the wheels 44.

Each of the wheel units includes a transducer such as an encoder 34, 36 or 38 for measuring the number of rotations of each respective wheel unit in order to measure the distance traveled by the respective wheel unit. The output from the respective encoders 34, 36, and/or 38 is fed to the microprocessor 32 which calculates the distance traveled by each of the wheel units.

The base also has an optical sensor 40 mounted at the centre of the base and facing downwardly through to detect reference marks of known positions on the floor of the studio or other area over which the base is moving from which the distance and orientation of the pedestal can be calculated.

The provision of encoders 34, 36, and 38 for measuring rotation of the wheels of the pedestal and thereby distances moved by the wheels will enable the distance and changing orientation of the pedestal to be measured. However, there are inevitably errors in the distances measured by the encoders driven by the wheels and unintended changes in the orientation of the pedestal with regard to the required track. The principal errors in measuring the distances moved by the pedestal arise from wear of the wheels on the tires supporting the pedestal and compression of the tires which affects the rolling radius of the tires and hence the assumption of the distance traveled for each rotation of the wheel as measured by the encoder. Misalignments in the direction in which the wheels face from true parallel cause wheel scrub between the tires and surface over which the wheels are running and cause the pedestal to move in an arc rather than in a true straight line in the required direction. The arcuate path has a virtual centre about which the pedestal rotates which will be referred to later.

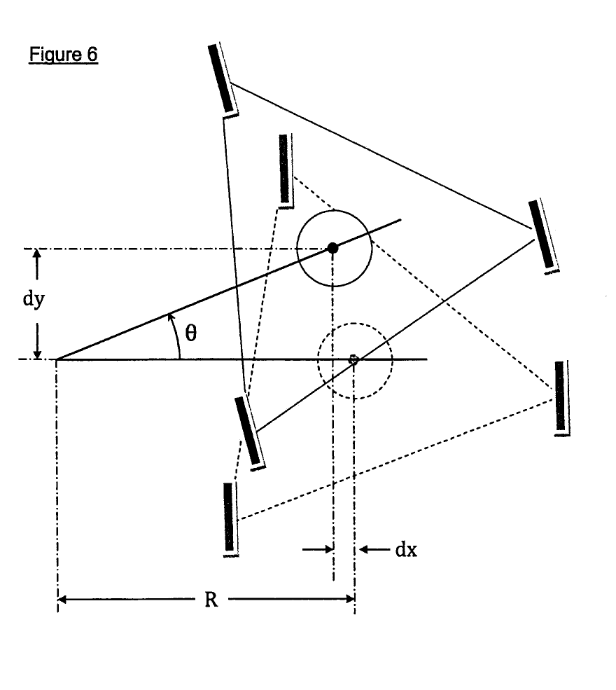

Each wheel will travel a distance proportional to its radius from that centre. The radial distance extends normal to the direction of the travel of the wheel as depicted in FIG. 5. If the wheel measurements were all true, they would all lie on a straight line through the instantaneous centre of rotation of the pedestal. The wheel measurements will not be the same as depicted in FIG. 5 and so it is necessary to find the best straight line through the points representing the distances traveled by each of the wheels. This can be done using a “least squares” curve fit or any other mathematical function for defining the best straight line passing through or near each of the points which represents the distance traveled by each of the wheels. The resulting line is projected back to zero velocity point on the x axis to give the centre of rotation of the pedestal again as depicted in FIG. 5.

The predetermined period between measurements of the distances traveled by the wheels can be selected but with an appropriate microprocessor and program, is conveniently of the order of a few milliseconds.

The distances traveled for each calculation and the change of orientation of the pedestal are summed to provide a total distance moved and a total change in orientation of the pedestal over a period of operation.

The system may, for example, form part of a virtual reality system in which virtual and real images are combined. Since the real image seen by the camera on the pedestal is departing slightly from the intended image as a result of the deviation of the camera from the intended path as indicated above, it is necessary to adjust the virtual image in the camera and the information from the microprocessor which is continuously determining deviation from the intended path is used to correct the virtual image.

Reference is now made to FIGS. 5 and 6 which depict diagrammatically how the change of orientation of the pedestal and the distance traveled from a previously known position and orientation are determined.

Referring to FIG. 5 of the drawings,

$$\begin{matrix}V 1 = \\ V 2 = \\ V 3 =\end{matrix} \} Measured wheel travel from previous positions \\ \begin{matrix}X 1 = \\ X 2 = \\ X 3 =\end{matrix} \} \begin{matrix}Distance normal to direction of travel between \\ each wheel and the column centre\end{matrix}$$

$$\begin{matrix}R = Radius from instantaneous centre of rotation to pedestal column \\ dx , dy = Change in position of column \\ θ = Change in orientation of pedestal base\end{matrix}$$

$$Let total number of wheels = N$$

Applying the least squares method to fit a line V(x)=Mx+B through the current measured wheel positions, where M and B are constants relating to the slope of the line and the intercept with the V-axis respectively

$$Let \text{:} \begin{matrix}{s}_{0} = N = 3 \\ {s}_{1} = {\sum }_{j = 1}^{N} {x}_{j} = ( {x}_{1} + {x}_{2} + {x}_{3} ) \\ {s}_{2} = {\sum }_{j = 1}^{N} {x}_{j}^{2} = ( {x}_{1}^{2} + {x}_{2}^{2} + {x}_{3}^{2} ) \\ {t}_{0} = {\sum }_{j = 1}^{N} {v}_{j} = ( {v}_{1} + {v}_{2} + {v}_{3} ) \\ {t}_{1} = {\sum }_{j = 1}^{N} {x}_{j} {v}_{j} = ( {x}_{1} {v}_{1} + {x}_{2} {v}_{2} + {x}_{3} {v}_{3} )\end{matrix}$$

$$M = \frac{3 {t}_{1} - {s}_{1} {t}_{0}}{3 {s}_{2} - {s}_{1}^{2}} \qquad B = \frac{{s}_{2} {t}_{0} - {s}_{1} {t}_{1}}{3 {s}_{2} - {s}_{1}^{2}} \qquad R = \frac{B}{M} = \frac{{s}_{2} {t}_{0} - {s}_{1} {t}_{1}}{3 {t}_{1} - {s}_{1} {t}_{0}}$$

$$Let \text{:} H = \frac{1}{\sqrt{1 + {M}^{2}}}$$

Therefore the change in orientation and position of the column centre are

$$θ = {tan}^{- 1} ( M ) \qquad dx = R ( H - 1 ) \qquad dy = RMH$$

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those skilled in the art, without departing from the spirit of the inventive concept the scope of which is to be determined by the following claims.

1. A pedestal for a TV, video or cine camera comprising a base supported on at least three steerable wheel units, a steering system for the wheel units for maintaining the wheel units in parallel alignment with one another, a monitoring system for the wheel units and the steering system and means for determining the distance moved by each wheel unit and the angle steered in relation to a fixed axis defined on the base, the monitoring system having processor means for calculating from the distances moved by every one of said at least three wheels and the angle steered by every one of said at least three wheels in relation to said fixed axis, the distance traveled and any change of orientation of the pedestal to enable the position and orientation of the pedestal to be determined in relation to a previously known position and orientation.

2. A pedestal as claimed in claim 1, wherein the monitoring system is programmed to determine from the as measured distances traveled by said at least three wheels and said angle steered with respect to the reference angle a closest approximation for the travel and orientation change of the pedestal.

3. A pedestal as claimed in claim 2, wherein the monitoring system relates the as measured distances of said at least three wheels using a selected mathematical function to determine the corresponding distance traveled by the pedestal and change of orientation of the pedestal.

4. A pedestal as claimed in claim 3, wherein the monitoring system is programmed to calculate said closest approximation of the values of distance traveled by the pedestal and orientation change of the pedestal using a “least squares rule” mathematical function.

5. A pedestal as claimed in claim 1, wherein the base of the pedestal is generally triangular and is supported on steerable wheel units located at the apices of the triangle.

6. A pedestal as claimed in claim 1, wherein one or more of the at least three wheel units are motorized wheel units.

7. A pedestal as claimed in claim 1, wherein the means for measuring the distance traveled by the pedestal wheels comprise means for counting the number of rotations of the wheels.

8. A pedestal as claimed in claim 7, wherein the means for counting the number of rotations of the wheels comprise transducers for each of the wheels.

9. A pedestal as claimed in claim 8, wherein the transducers for each of the wheels comprise encoders.

10. A pedestal as claimed in claim 1, wherein the means to determine the angle steered by the wheels in relation to a neutral reference position comprise means to measure movement of the steering mechanism for the wheels in relation to said reference.

11. A pedestal as claimed in claim 10, wherein the means to measure movement of the steering mechanism in relation the reference comprise transducer means.

12. A pedestal as claimed in claim 11, wherein the transducer means comprise an encoder.

13. A TV, video or cine camera pedestal comprising a base supported on at least three steerable wheel units, a steering system for the wheel units for maintaining the wheel units in parallel alignment with one another, a monitoring system for the wheel units and the steering system and one or more transducers associated with each of the wheels for determining the distance moved by each wheel unit by counting the number of rotations of the wheels and the angle steered in relation to a fixed axis defined on the base, the monitoring system having a processor for calculating from the distances moved by every one of said at least three wheels and the angle steered by every one of said at least three wheels in relation to said fixed axis, the distance traveled and any change of orientation of the pedestal to enable the position and orientation of the pedestal to be determined in relation to a previously known position and orientation.

14. A TV, video or cine camera pedestal as claimed in claim 13 wherein the one or more transducers comprise an encoder.
